(19) United States
(12) Patent Application Publication
(10) Pub. No.: US 2026/0221693 A1
(43) Pub. Date: Jul. 30, 2026

(54) ELECTRICAL CONNECTOR ASSEMBLY HAVING A CONNECTOR POSITION ASSURANCE DEVICE WITH A DATA MATRIX REVEAL

(71) Applicant: TE Connectivity Solutions GmbH, Schaffhausen (CH)

(72) Inventor: Anton STOYANOV, Winston Salem, NC (US)

(21) Appl. No.: 19/441,361

(22) Filed: Jan. 6, 2026

Related U.S. Application Data
(60) Provisional application No. 63/751,535, filed on Jan. 30, 2025.
(60) Provisional application No. 63/931,776, filed on Dec. 5, 2025.

(51) Int. Cl. H01R 13/641; H01R 13/514; H01R 13/627; H01R 13/629; H01R 13/645

(52) U.S. Cl. CPC H01R 13/641; H01R 13/514; H01R 13/6272; H01R 13/62938; H01R 13/6456

(57) ABSTRACT

An electrical connector assembly includes an electrical connector having a connector housing holding contacts and an outer housing receiving the electrical connector. A CPA device is coupled to the outer housing and movable between a pre-stage position and a seated position. The electrical connector assembly includes a data matrix that includes a first data matrix portion and a second data matrix portion coupled to the CPA device and movable with the CPA device. The first and second data matrix portions are separated from each other when the CPA device is in the pre-stage position to form a split data matrix. The first and second data matrix portions are aligned adjacent each other when the CPA device is in the seated position to form a united data matrix. The split data matrix is unscannable and the united data matrix is scannable by a data scanning device.

### CROSS REFERENCE TO RELATED APPLICATIONS

This application claims priority to U.S. Application No. 63/751,535, filed 30Jan. 2025 and to U.S. Application No. 63/931,776, filed 5Dec. 2025, the subject matter of which is herein incorporated by reference in its entirety.

### BACKGROUND OF THE INVENTION

The subject matter herein relates generally to electrical connectors having connector position assurance (CPA) devices.

Electrical connector assemblies used in automotive, industrial, and consumer electronic systems increasingly incorporate multiple electrical connectors grouped within a common outer housing. Such multi-connector arrangements reduce packaging size and simplify routing of wire harnesses by consolidating several individual connectors into a single modular interface. Each of the individual connectors within the housing often includes its own terminal set, latch features, and mating interface for engagement with a corresponding mating connector component.

To ensure proper seating and full engagement of each connector during assembly, many known multi-connector assemblies employ connector position assurance (CPA) devices. Conventional CPA devices are typically associated with a single connector interface and are configured to move between different positions to confirm that a corresponding inner connector is fully inserted into the outer housing. In multi-connector assemblies, this generally results in the use of a separate CPA device for each connector contained within the common housing.

While effective for single-connector applications, the use of multiple independent CPA devices in a shared housing presents several drawbacks. Each CPA must be individually installed, manipulated, and verified during assembly, increasing the total number of manufacturing steps and handling operations. The presence of multiple CPA devices also adds complexity to the assembly workflow, increases part count, and may introduce opportunities for assembly errors if one or more CPA devices are not properly actuated. Furthermore, additional CPA components contribute to increased material cost and require additional space within or on the housing, which may limit design flexibility.

Some electrical connector assemblies utilize a data matrix reveal after the connector is fully mated and the CPA device is engaged as a form of redundancy to ensure that the connectors are fully mated. However, the design of some CPA devices do not lend easy or convenient reveal locations for a data matrix. For example, the slide direction may not leave an adequate location for the data matrix reveal, such as dues to space constraints.

Accordingly, there is a need for improved connector assemblies that incorporate CPA functionality for multiple connectors while providing redundant assembly assurance.

### BRIEF DESCRIPTION OF THE INVENTION

In an embodiment, an electrical connector assembly is provided and includes an electrical connector for mating with a mating connector. The electrical connector includes a connector housing holding contacts. The electrical connector includes a latching element. The electrical connector includes an actuation element. The electrical connector assembly includes an outer housing that includes an outer wall surrounding a cavity receiving the electrical connector. The outer housing includes a latch configured to be operably coupled to the latching element to secure the electrical connector in the cavity. The outer housing includes a blocking surface. The electrical connector assembly includes a connector position assurance (CPA) device coupled to the outer housing. The CPA device is movable between a pre-stage position and a seated position. The CPA device includes a CPA element coupled to the blocking surface in the pre-stage position. The blocking surface blocks the CPA device from moving from the pre-stage position to the seated position. The CPA element is configured to interface with the actuation element of the electrical connector. The actuation element is configured to move the CPA element to a clearance position released from the blocking surface when the electrical connector is fully inserted into the cavity. Movement of the CPA device into the seated position provides a mechanical indication that the electrical connector is properly positioned within the cavity of the outer housing and wherein movement of the CPA device is prevented when the electrical connector is not fully inserted in the outer housing. The electrical connector assembly includes a data matrix that includes a first data matrix portion and a second data matrix portion. The second data matrix portion is coupled to the CPA device and movable with the CPA device. The first and second data matrix portions are separated from each other when the CPA device is in the pre-stage position to form a split data matrix. The first and second data matrix portions are aligned adjacent each other when the CPA device is in the seated position to form a united data matrix. The split data matrix is unscannable and the united data matrix is scannable by a data scanning device.

In another embodiment, an electrical connector assembly is provided and includes an electrical connector for mating with a mating connector. The electrical connector includes a connector housing holding contacts. The electrical connector includes a latching element. The electrical connector includes an actuation element. The electrical connector assembly includes an outer housing that includes an outer wall surrounding a cavity receiving the electrical connector. The outer housing includes a latch configured to be operably coupled to the latching element to secure the electrical connector in the cavity. The outer housing includes a blocking surface. The electrical connector assembly includes a connector position assurance (CPA) device coupled to the outer housing. The CPA device is movable between a pre-stage position and a seated position. The CPA device includes a CPA element coupled to the blocking surface in the pre-stage position. The blocking surface blocks the CPA device from moving from the pre-stage position to the seated position. The CPA element is configured to interface with the actuation element of the electrical connector. The actuation element is configured to move the CPA element to a clearance position released from the blocking surface when the electrical connector is fully inserted into the cavity. Movement of the CPA device into the seated position provides a mechanical indication that the electrical connector is properly positioned within the cavity of the outer housing and wherein movement of the CPA device is prevented when the electrical connector is not fully inserted in the outer housing. The electrical connector assembly includes a data matrix that includes a first data matrix portion and a second data matrix portion. The first data matrix portion is coupled to the outer housing. The second data matrix portion is coupled to the CPA device and movable with the CPA device relative to the first data matrix portion. The first and second data matrix portions are separated from each other when the CPA device is in the pre-stage position to form a split data matrix. The first and second data matrix portions are aligned adjacent each other when the CPA device is in the seated position to form a united data matrix. The split data matrix is unscannable and the united data matrix is scannable by a data scanning device.

In a further embodiment, an electrical connector system is provided and includes an electrical connector assembly that includes an outer housing holding an electrical connector and a connector position assurance (CPA) device. The electrical connector includes a connector housing holding contacts. The electrical connector includes a latching element. The electrical connector includes an actuation element. The outer housing includes an outer wall surrounding a cavity receiving the electrical connector. The outer housing includes a mating assist tab. The outer housing includes a latch configured to be operably coupled to the latching element to secure the electrical connector in the cavity. The outer housing includes a blocking surface. The CPA device is movable between a pre-stage position and a seated position. The CPA device includes a CPA element coupled to the blocking surface in the pre-stage position. The blocking surface blocks the CPA device from moving from the pre-stage position to the seated position. The CPA element is configured to interface with the actuation element of the electrical connector. The actuation element is configured to move the CPA element to a clearance position released from the blocking surface when the electrical connector is fully inserted into the cavity. Movement of the CPA device into the seated position provides a mechanical indication that the electrical connector is properly positioned within the cavity of the outer housing and wherein movement of the CPA device is prevented when the electrical connector is not fully inserted in the outer housing. The electrical connector system includes a mating connector assembly that includes a mating housing holding a mating electrical connector and a mating assist device. The mating electrical connector includes mating contacts configured to be mated with the contacts of the electrical connector. The mating assist device includes a lever configured to engage the mating assist tab and configured to drive at least one of the mating connector assembly and the electrical connector assembly in a mating direction as the lever is rotated between an unactuated position and an actuated position. The electrical connector system includes a data matrix includes a first data matrix portion and a second data matrix portion. The first data matrix portion is coupled to the lever and movable with the lever between the actuated position and the unactuated position. The second data matrix portion is coupled to the CPA device and movable with the CPA device. The first and second data matrix portions are separated from each other when the CPA device is in the pre-stage position to form a split data matrix. The first and second data matrix portions are aligned adjacent each other when the CPA device is in the seated position to form a united data matrix. The split data matrix is unscannable and the united data matrix is scannable by a data scanning device.

### BRIEF DESCRIPTION OF THE DRAWINGS

FIG. 1 illustrates an electrical connector assembly in accordance with an exemplary embodiment.

FIG. 2 is a perspective view of the electrical connector assembly in accordance with an exemplary embodiment.

FIG. 3 is an exploded, perspective view of the electrical connector assembly in accordance with an exemplary embodiment.

FIG. 4 is a perspective view of the electrical connector assembly showing the CPA device in a pre-stage position in accordance with an exemplary embodiment.

FIG. 5 is a cross-sectional view of the electrical connector assembly showing the CPA device in the pre-stage position in accordance with an exemplary embodiment.

FIG. 6 is a cross-sectional view of the electrical connector assembly showing the CPA device in the pre-stage position with the first and second electrical connectors removed to illustrate the CPA device relative to the outer housing in accordance with an exemplary embodiment.

FIG. 7 is a top perspective view of the electrical connector assembly showing the CPA device in the pre-stage position and showing a split data matrix in accordance with an exemplary embodiment.

FIG. 8 is a top view of a portion of the electrical connector assembly showing the split data matrix in accordance with an exemplary embodiment.

FIG. 9 is a top perspective view of the electrical connector assembly showing the CPA device in the seated position and showing the united data matrix in accordance with an exemplary embodiment.

FIG. 10 is a top view of a portion of the electrical connector assembly showing the united data matrix in accordance with an exemplary embodiment.

FIG. 11 is a perspective view of an electrical connector system showing a mating connector assembly partially mated with the electrical connector assembly in accordance with an exemplary embodiment.

FIG. 12 is another perspective view of the electrical connector system showing the mating connector assembly partially mated with the electrical connector assembly in accordance with an exemplary embodiment.

FIG. 13 is a perspective view of an electrical connector system showing the mating connector assembly fully mated with the electrical connector assembly in accordance with an exemplary embodiment.

FIG. 14 is a top view of a portion of the electrical connector system showing the data matrix in a united and scannable state in accordance with an exemplary embodiment.

### DETAILED DESCRIPTION OF THE INVENTION

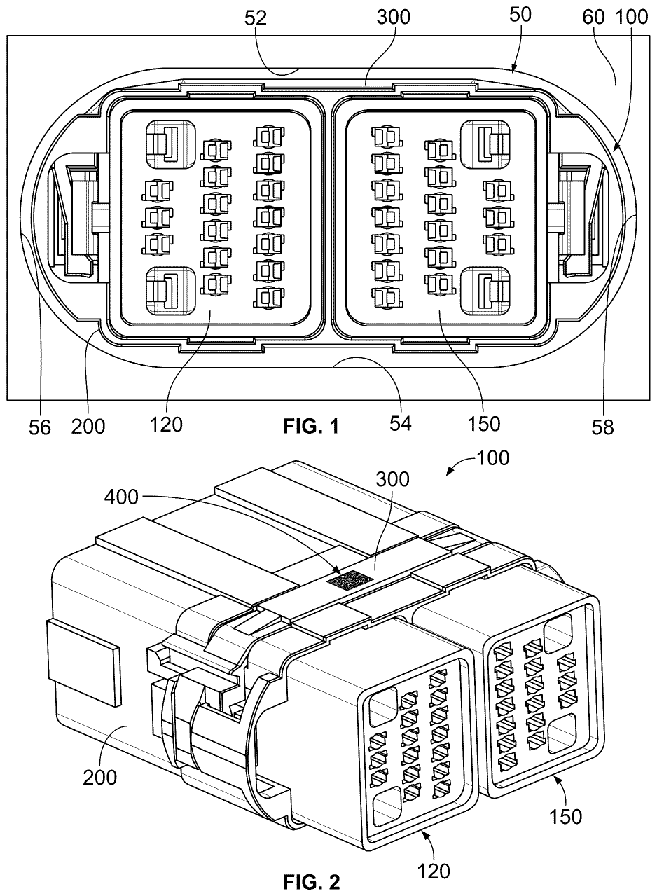

FIG. 1 illustrates an electrical connector assembly 100 in accordance with an exemplary embodiment. The electrical connector assembly 100 may be configured for use in a vehicle. For example, the electrical connector assembly 100 is configured to be mounted at an opening 50 in a panel 60. The panel 60 may be part of a vehicle structure, such as a door panel, body side panel, or any sheet-metal or composite structure through which electrical interfaces must pass. The electrical connector assembly 100 may be mounted to other structures, such as a chassis, header, circuit board, or other mounting structure.

In an exemplary embodiment, the electrical connector assembly 100 is a multi-connector arrangement having multiple electrical connectors, such as a first electrical connector 120 and a second electrical connector 150, grouped together within a common outer housing 200. However, in alternative embodiments, the electrical connector assembly 100 may include a single electrical connector. In an exemplary embodiment, the electrical connector assembly 100 incorporates a connector position assurance (CPA) device 300 to verify full seating of the electrical connector(s) 120, 150 within the outer housing 200.

The outer housing 200 may include a mounting flange, latching fingers, or other retention features adapted to engage the edges of the panel opening 50 so that the outer housing 200 is held in a fixed position relative to the panel 60. When installed, the outer housing 200 spans the panel opening 50 and provides an interface accessible from the interior or exterior side of the panel 60, depending on application requirements. The electrical connector assembly 100 may also include environmental sealing features, such as perimeter gaskets, wire seals, or moisture barriers, formed around the outer housing 200 or in the interior of the outer housing 200 to prevent water, dust, and debris from entering the panel opening 50.

In various embodiments, the electrical connector assembly 100 may be positioned at a door-to-body interface of a vehicle, where electrical circuits must pass between a movable door and a stationary body structure. In such applications, the outer housing 200 is mounted to the door panel 60 to position the first and second electrical connectors 120, 150 at the door panel 60, while the mating connector is positioned on the vehicle body side. The arrangement allows for a robust and serviceable electrical interface that can withstand repeated door opening and closing cycles, environmental exposure, and mechanical stress. The CPA device 300 ensures that the first and second electrical connectors 120, 150 within the door-side housing remains fully seated and provides reliable electrical continuity as the vehicle operates.

FIG. 2 is a perspective view of the electrical connector assembly 100 in accordance with an exemplary embodiment. FIG. 2 shows the first and second electrical connectors 120, 150 fully inserted into the outer housing 200 and secured in the outer housing 200. FIG. 2 shows the CPA device 300 in a seated position.

In an exemplary embodiment, the electrical connector assembly 100 includes a scannable data matrix 400 configured to be scanned by a data scanning device. For example, the data matrix 400 may be machine-readable and able to be read by a sensor of the data scanning device. The data matrix 400 may be one of a one-dimensional barcode, a two-dimensional barcode, or a three-dimensional barcode. The data matrix 400 may be a quick response (QR) code. The data matrix 400 is readable by a reader or other type of scanning device. The data matrix 400 provides a redundant position assurance to the installer providing confirmation that the CPA device 300 is properly seated and thus the electrical connector assembly 100 is properly assembled.

In an exemplary embodiment, the data matrix 400 includes different portions that are movable relative to each other that may be movable from a split position, where the portions are spaced apart from each other, to a united position, where the portions are joined or united to form the scannable data matrix 400. For example, the data matrix 400 may include a first data matrix portion 402 on the outer housing 200 or other component and a second data matrix portion 404 on the CPA device 300 and movable with the CPA device 300. The first and second data matrix portions 402, 404 are separated from each other when the CPA device 300 is in the pre-stage position to form a split data matrix that is unscannable. The first and second data matrix portions 402, 404 are aligned adjacent each other when the CPA device 300 is in the seated position to form a united data matrix that is scannable by the data scanning device.

In an exemplary embodiment, the data matrix 400 is only scannable when the CPA device 300 is in the seated position. The data matrix 400 is unscannable when the CPA device 300 is in the pre-stage position. As such, scanning of the data matrix 400 certifies to the installer that the first electrical connector 120 is fully mated, that the second electrical connector 150 is fully mated, and that the CPA device 300 is fully engaged. All three events can be certified by scanning the single data matrix 400, without the need for providing multiple CPA devices or multiple data matrix. The scannable data matrix 400 provides a secondary indication to the installer that the connectors 120, 150 are fully mated and that the CPA device 300 is fully engaged reducing the risk of incomplete connections during assembly and enhancing the overall system reliability.

In an exemplary embodiment, the CPA device 300 is configured to be operably coupled to both the first and second electrical connectors 120, 150. The CPA device 300 may be blocked or prevented from movement when either of the electrical connectors 120, 150 are not fully inserted into the outer housing 200 thus providing position assurance for both the first and second electrical connectors 120, 150 using a single or common CPA component.

The CPA device 300 is movable from a pre-stage position to the seated position only when the first and second electrical connectors 120, 150 are fully inserted into the outer housing 200. For example, the CPA device 300 may be moved inward, such as in a direction perpendicular to the mating direction of the electrical connector assembly 100. When either of the first electrical connector 120 or the second electrical connector 150 are not properly installed, a blocking feature of the CPA device 300 interferes with a corresponding surface of the outer housing 200, thereby preventing movement of the CPA device 300 into the seated position. Once the first and second electrical connectors 120, 150 reach their intended depth, latching elements of the outer housing 200 and the electrical connectors 120, 150 are properly engaged to secure the electrical connectors 120, 150 in the outer housing 200 and removing the blocking condition for the CPA device 300 thus allowing the CPA device 300 to be advanced from the pre-stage position to the seated position. Movement of the CPA device into the seated position provides a mechanical verification that the electrical connectors 120, 150 are properly positioned within the outer housing 200.

In some embodiments, the CPA device 300, when fully actuated, also provides a secondary locking function that prevents inadvertent withdrawal or unlatching of the electrical connectors 120, 150, such as due to vibration, thermal cycling, or mechanical loads encountered during vehicle operation. The CPA device 300 may engage portions of the electrical connectors 120, 150 to restrict reverse movement, or may lock one or more latch arms in an engaged condition.

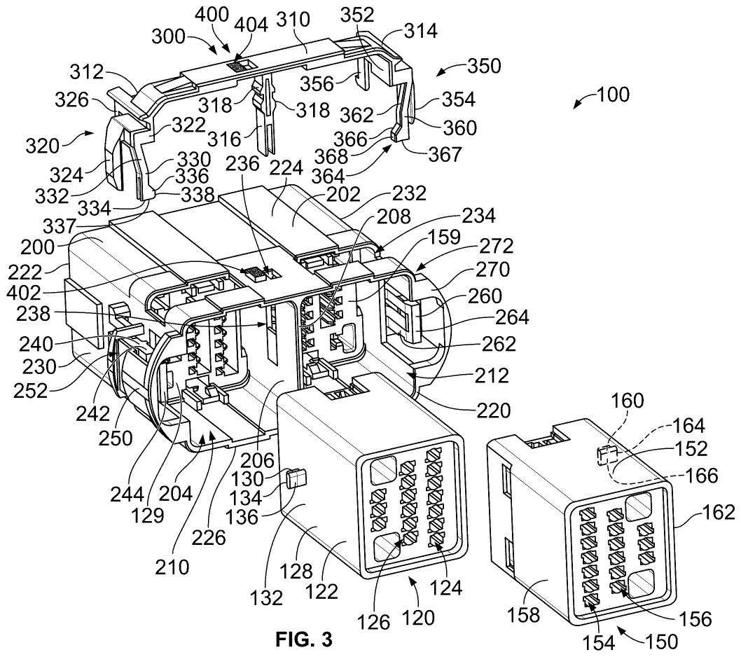

FIG. 3 is an exploded, perspective view of the electrical connector assembly 100 in accordance with an exemplary embodiment. The electrical connector assembly 100 is a multi-connector arrangement having the multiple electrical connectors 120, 150 arranged within a single, common outer housing 200. The CPA device 300 is a multi-connector CPA device configured to be operably coupled to the multiple electrical connectors 120, 150 to provide proper connector position assurance for the multiple electrical connectors 120, 150 using a single, common CPA component. In an exemplary embodiment, the electrical connector assembly 100 includes the data matrix 400 with the data matrix portions 402, 404 on different components, such as on the outer housing 200 and the CPA device 300, respectively, that may be joined and revealed, and thus scannable, when the electrical connector assembly 100 is assembled.

The first electrical connector 120 is separate and discrete from the second electrical connector 150. The first and second electrical connectors 150 may be similar to each other, or identical to each other, and like components are identified with like reference numerals. The first electrical connector 120 may provide signal and/or power connections with a corresponding mating electrical connector. Similarly, the second electrical connector 150 may provide signal and/or power connections with a corresponding mating electrical connector. The electrical connector assembly 100 may include additional electrical connectors (not shown), such as a third electrical connector located between the first and second electrical connectors 120, 150. The single data matrix 400 may be used to assure proper assembly of the multiple electrical connectors 120, 150.

The first electrical connector 120 includes a first connector housing 122 holding first contacts 124. The first contacts 124 may be terminated to ends of wires (not shown). The first contacts 124 may be arranged in contact channels 126 passing through the first connector housing 122. In various embodiments, the first connector housing 122 is a multipiece housing having a front housing 128 and a rear housing 129. The front housing 128 holds the first contacts 124 and may be assembled through a front of the outer housing 200. The rear housing 129 may hold the wires and may be assembled through a front or a rear of the outer housing 200. In an exemplary embodiment, the CPA device 300 is configured to interface with the front housing 128 to assure proper loading of the front housing 128 into the outer housing 200.

In an exemplary embodiment, the first electrical connector 120 includes a first latching element 130 extending from a side 132 of the first connector housing 122. The first latching element 130 extends to a distal end 134. The first latching element 130 includes a latching surface 136, such as at a front surface of the first latching element 130. In an exemplary embodiment, the latching surface 136 is configured to interface with a latching element of the outer housing 200 to latchably secure the first electrical connector 120 in the outer housing 200. In an exemplary embodiment, the distal end 134 is configured to interface with a portion of the CPA device 300 to release the CPA device 300 and allow the CPA device 300 to move from a pre-stage position to the seated position when the first electrical connector 120 is fully inserted into the outer housing 200.

The second electrical connector 150 includes a second connector housing 152 holding second contacts 154. The second contacts 154 may be terminated to ends of wires (not shown). The second contacts 154 may be arranged in contact channels 156 passing through the second connector housing 152. In various embodiments, the second connector housing 152 is a multipiece housing having a front housing 158 and a rear housing 159. The front housing 158 holds the second contacts 154 and may be assembled through a front of the outer housing 200. The rear housing 159 may hold the wires and may be assembled through a front or a rear of the outer housing 200. In an exemplary embodiment, the CPA device 300 is configured to interface with the front housing 158 to assure proper loading of the front housing 158 into the outer housing 200.

In an exemplary embodiment, the second electrical connector 150 includes a second latching element 160 (shown in phantom) extending from a side 162 of the second connector housing 152. The second latching element 160 extends to a distal end 164. The second latching element 160 includes a latching surface 166, such as at a front surface of the second latching element 160. In an exemplary embodiment, the latching surface 166 is configured to interface with a latching element of the outer housing 200 to latchably secure the second electrical connector 150 in the outer housing 200. In an exemplary embodiment, the distal end 164 is configured to interface with a portion of the CPA device 300 to release the CPA device 300 and allow the CPA device 300 to move from a pre-stage position to the seated position when the second electrical connector 150 is fully inserted into the outer housing 200.

The outer housing 200 is configured to receive the electrical connectors 120, 150 and the CPA device 300. In an exemplary embodiment, the outer housing 200 is manufactured from a dielectric material, such as a plastic material. For example, the outer housing 200 may be a molded part. The outer housing 200 includes an outer wall 202 surrounding a cavity 204. The outer housing 200 may include one or more inner walls 206 in the cavity 204. For example, the outer housing 200 includes a central wall 208 that divides the cavity 204 into a first connector chamber 210 and a second connector chamber 212. The first connector chamber 210 is configured to receive the first electrical connector 120 and the second connector chamber 212 is configured to receive the second electrical connector 150. The cavity 204 may be divided into other chambers that receive other electrical connectors in alternative embodiments.

The outer housing 200 extends between a front 220 and the rear 222. The outer housing 200 includes a top 224 and a bottom 226. The outer housing 200 includes a first side 230 and a second side 232. In various embodiments, the outer housing 200 is generally rectangular shaped. For example, the top 224 and the bottom 226 may be generally planar and extend parallel to each other. The first side 230 and the second side 232 may be generally planar and extend parallel to each other. In the illustrated embodiment, the central wall 208 is approximately centered between the first and second sides 230, 232 such that the first and second connector chambers 210, 212 have similar sizes. However, in alternative embodiments, the central wall 208 may be located closer to the first side 230 or the second side 232 to form different size chambers.

In an exemplary embodiment, the outer housing 200 includes a CPA pocket 234 that receives the CPA device 300. The CPA pocket 234 may be located at the top 224 and/or the first side 230 and/or the second side 232. The CPA pocket 234 extends into the outer housing 200 and allows the CPA device 300 to be recessed within the outer housing 200, such as to reduce an overall profile of the electrical connector assembly 100. The CPA pocket 234 may be open through the outer housing 200 to the cavity 204. Such opening may allow portions of the CPA device 300 to extend into the cavity 204.

In an exemplary embodiment, the outer housing 200 includes an opening 236 configured to receive a portion of the CPA device 300. The opening 236 may be aligned with the central wall 208 to allow a portion of the CPA device 300 to extend along the central wall 208. The central wall 208 may include an opening 238 passing therethrough that receives a portion of the CPA device 300. For example, the CPA device 300 may be received in the openings 236, 238 to interface with the first and second electrical connectors 120, 150 when the first and second electrical connectors 120, 150 are loaded into the first and second connector chambers 210, 212.

The outer housing 200 includes a first latch 240 at the first side 230. The first latch 240 is configured to be latchably coupled to the first electrical connector 120, such as to the first latching element 130. In an exemplary embodiment, the first latch 240 is a deflectable latch configured to be released to release the first electrical connector 120 from the outer housing 200. In an exemplary embodiment, the first latch 240 includes a latch arm 242 and a latching finger 244 at a distal end of the latch arm 242 configured to engage the latching surface 136 of the first latching element 130.

In an exemplary embodiment, the outer housing 200 includes a first latch shroud 250 that surrounds a portion of the first latch 240. The first latch shroud 250 may extend outward from the first side 230. In the illustrated embodiment, the first latch shroud 250 has a curvature, which may match a curvature of the opening 50 in the panel 60 (shown in FIG. 1). In an exemplary embodiment, the outer housing 200 includes a first guide track 252 configured to receive a portion of the CPA device 300. In the illustrated embodiment, the first guide track 252 is located in the first latch shroud 250. The first guide track 252 is used to guide movement of the CPA device 300 relative to the outer housing 200.

The outer housing 200 includes a second latch 260 at the second side 232. The second latch 260 is configured to be latchably coupled to the second electrical connector 150, such as to the second latching element 160. In an exemplary embodiment, the second latch 260 is a deflectable latch configured to be released to release the second electrical connector 150 from the outer housing 200. In an exemplary embodiment, the second latch 260 includes a latch arm 262 and a latching finger 264 at a distal end of the latch arm 262 configured to engage the latching surface 166 of the second latching element 160.

In an exemplary embodiment, the outer housing 200 includes a second latch shroud 270 that surrounds a portion of the second latch 260. The second latch shroud 270 may extend outward from the second side 232. In the illustrated embodiment, the second latch shroud 270 has a curvature, which may match a curvature of the opening 50 in the panel 60 (shown in FIG. 1). In an exemplary embodiment, the outer housing 200 includes a second guide track 272 configured to receive a portion of the CPA device 300. In the illustrated embodiment, the second guide track 272 is located in the second latch shroud 270. The second guide track 272 is used to guide movement of the CPA device 300 relative to the outer housing 200.

In an exemplary embodiment, the outer housing 200 includes a data matrix area 280 that includes one of the portions of the data matrix 400, such as the first data matrix portion 402. In the illustrated embodiment, the data matrix area 280 is at the top 224 of the outer housing 200. Other locations are possible in alternative embodiments. The first data matrix portion 402 may be printed, adhered, or otherwise applied to the outer housing 200 at the data matrix area 280. In an exemplary embodiment, the outer housing 200 includes embossed walls 282 extending along the first data matrix portion 402 on one or more sides thereof, such as along three sides thereof. The embossed walls 282 may form a pocket 284 that defines a position for the first data matrix portion 402. The embossed walls 282 stand proud of the first data matrix portion 402 to protect the first data matrix portion 402. In an exemplary embodiment, the outer housing 200 may include an elevated platform 286 at the data matrix area 280. The first data matrix portion 402 is coupled to the outer housing 200 on the platform 286 such that the first data matrix portion 402 is elevated above other portions of the outer housing 200. The embossed walls 282 may extend outward from the platform 286.

In an exemplary embodiment, the CPA device 300 is a unitary, single piece component configured to be coupled to the outer housing 200 and interface with the multiple electrical connectors 120, 150 received in the outer housing 200. The CPA device 300 includes a main body 310, a first CPA element 320 extending from a first side 312 of the main body 310, and a second CPA element 350 extending from a second side 314 of the main body 310. The first CPA element 320 is configured to interface with the first latch 240 and the first electrical connector 120. The second CPA element 350 is configured to interface with the second latch 260 and the second electrical connector 150.

In an exemplary embodiment, the CPA device 300 includes a center blocking finger 316 extending from an inner surface of the main body 310. The center blocking finger 316 is configured to be positioned between the first and second electrical connectors 120, 150 and may interface directly with the first and second electrical connectors 120, 150 when the first and second electrical connectors 120, 150 are inserted into the first and second connector chambers 210, 212. In an exemplary embodiment, the center blocking finger 316 is received in the opening 236 and the outer wall 202 to extend into the cavity 204. In an exemplary embodiment, the center blocking finger 316 is configured to be received in the opening 238 in the central wall 208 such that the center blocking finger 316 is positioned in the first connecting chamber 210 and the second connecting chamber 212 to interface with the first and second electrical connectors 120, 150. In an exemplary embodiment, the center blocking finger 316 includes protrusions 318, such as ribs along the opposite sides of the center blocking finger 316. The protrusions 318 are configured to engage the outer housing 200, such as the top wall, to hold the CPA device 300 at various positions. For example, the protrusions 318 may engage the outer wall 202 to hold the CPA device 300 at a pre-stage position. The protrusions 318 may hold the main body 310 at an elevated position above the top wall of the outer housing 200.

In an exemplary embodiment, the main body 310 is located at a top of the CPA device 300. The first and second CPA elements 320, 350 extend downward from the main body 310 at the opposite sides 312, 314 thereof. The main body 310 is configured to be received in the CPA pocket 234, such as along the top 224 of the outer housing 200. The first and second CPA elements 320, 350 may be received in the CPA pocket 234. In an exemplary embodiment, the first and second CPA elements 320, 350 are configured to be received in the first latch shroud 250 and a second latch shroud 270, respectively. The latch shrouds 250, 270 may cover or protect the components of the CPA elements 320, 350.

In an exemplary embodiment, the CPA device 300 includes a data matrix area 380 that includes one of the portions of the data matrix 400, such as the second data matrix portion 404. In the illustrated embodiment, the data matrix area 380 is along the main body 310, such as approximately centered along the main body 310. Other locations are possible in alternative embodiments. The second data matrix portion 404 may be printed, adhered, or otherwise applied to the CPA device 300 at the data matrix area 380. In an exemplary embodiment, the CPA device 300 includes embossed walls 382 extending along the second data matrix portion 404 on one or more sides thereof, such as along three sides thereof. The embossed walls 382 may form a pocket 384 that defines a position for the second data matrix portion 404. The embossed walls 382 stand proud of the second data matrix portion 404 to protect the second data matrix portion 404. In an exemplary embodiment, the CPA device 300 includes a data matrix window 386 adjacent to the pocket 384. The data matrix window 386 is configured to be aligned with the first data matrix portion 402 and is configured to receive the first data matrix portion 402. For example, the data matrix window 386 may receive the platform 286 and the first data matrix portion 402 to align the first data matrix portion 402 with the second data matrix portion 404. For example, the platform 286 may position the first data matrix portion 402 coplanar with the second data matrix portion 404. The second data matrix portion 404 is positioned adjacent the data matrix window 386 such that when the first data matrix portion 402 is received in the data matrix window 386, the first and second data matrix portions 402, 404 may be joined or united to form the scannable data matrix 400.

The first CPA element 320 includes a base 322 and a first engagement feature 330 extending from the base 322. For example, the first engagement feature 330 extends downward from the base 322. In the illustrated embodiment, the first engagement feature 330 is located at a front of the base 322. Other locations are possible in alternative embodiments. The first engagement feature 330 defines a blocking feature of the CPA device 300 configured to interfere with a corresponding surface of the outer housing 200, such as the first latch 240, thereby preventing movement of the CPA device 300 to the seated position. For example, the first engagement feature 330 is movable between an engagement position in the clearance position. In the engagement position, the first engagement feature 330 engages the first latch 240 and holds the CPA device 300 in the pre-stage position. The CPA device 300 is unable to move from the pre-stage position until the first engagement feature 330 is actuated to the clearance position. In an exemplary embodiment, the first engagement feature 330 is configured to interface with the first electrical connector 120 when the first electrical connector 120 is in the fully loaded position to move the first engagement feature 330 to the clearance position. For example, only when the first electrical connector 120 is in the fully loaded position is the blocking condition for the CPA device 300 removed, thus allowing the CPA device 300 to be advanced from the pre-stage position to the seated position.

In various embodiments, the first CPA element 320 includes a first guide finger 324 extending from the base 322 used to guide mating of the first CPA element 320 with the outer housing 200, such as with the first latch shroud 250. For example, the first guide finger 324 may be received in the first guide track 252 to guide movement of the first CPA element 320, such as in a vertical direction. In the illustrated embodiment, the first guide finger 324 is located at an outer end of the first CPA element 320. Other locations are possible in alternative embodiments.

In various embodiments, the first CPA element 320 includes a first latch blocking finger 326 extending from the base 322. The first latch blocking finger 326 is configured to interface with the first latch 240. For example, the first latch blocking finger 326 may be positioned between the first latch 240 and the first side 230 of the outer housing 200 to block actuation of the first latch 240 when the first CPA element 320 is in the seated position. In the illustrated embodiment, the first latch blocking finger 326 is located at the rear of the base 322. Other locations are possible in alternative embodiments.

In an exemplary embodiment, the first engagement feature 330 is configured to interface with a portion of the outer housing 200, such as the first latch 240. The first engagement feature 330 includes a deflectable spring beam 332 that extends from the base 322 to a distal end 334. The first engagement feature 330 includes a blocking tab 336 extending inward from the spring beam 332 at the distal end 334. The blocking tab 336 includes an end surface 337 and an inner surface 338. The end surface 337 of the blocking tab 336 is configured to engage and abut against a portion of the first latch 240 to block movement of the first CPA element 320 relative to the outer housing 200 and the first latch 240. When the end surface 337 of the blocking tab 336 engages the first latch 240, the CPA device 300 is held in the pre-stage position and is unable to move to the seated position. In an exemplary embodiment, the inner surface 338 of the blocking tab 336 of the first engagement feature 330 is configured to interface with the first electrical connector 120 when the first electrical connector 120 is plugged into the first connector chamber 210. For example, the first inner surface 338 of the blocking tab 336 may interface with the first latching element 130 (when the first electrical connector 120 is fully plugged into the first connector chamber 210) and the first latching element 130 deflects the spring beam 332 of the first engagement feature 330 to the clearance position. The end surface 337 of the blocking tab 336 is released from the first latch 240 in the clearance position (for example, the blocking condition is removed) to allow the CPA device 300 to move to the seated position.

The second CPA element 350 includes a base 352 and a second engagement feature 360 extending from the base 352. For example, the second engagement feature 360 extends downward from the base 352. In the illustrated embodiment, the second engagement feature 360 is located at a front of the base 352. Other locations are possible in alternative embodiments. The second engagement feature 360 defines a blocking feature of the CPA device 300 configured to interfere with a corresponding surface of the outer housing 200, such as the second latch 260, thereby preventing movement of the CPA device 300 to the seated position. For example, the second engagement feature 360 is movable between an engagement position and a clearance position. In the engagement position, the second engagement feature 360 engages the second latch 260 and holds the CPA device 300 in the pre-stage position. The CPA device 300 is unable to move from the pre-stage position until the second engagement feature 360 is actuated to the clearance position. In an exemplary embodiment, the second engagement feature 360 is configured to interface with the second electrical connector 150 when the second electrical connector 150 is in the fully loaded position to move the second engagement feature 360 to the clearance position. For example, only when the second electrical connector 150 is in the fully loaded position is the blocking condition for the CPA device 300 removed, thus allowing the CPA device 300 to be advanced from the pre-stage position to the seated position.

In various embodiments, the second CPA element 350 includes a second guide finger 354 extending from the base 352 used to guide mating of the second CPA element 350 with the outer housing 200, such as with the second latch shroud 270. For example, the second guide finger 354 may be received in the second guide track 272 to guide movement of the second CPA element 350, such as in a vertical direction. In the illustrated embodiment, the second guide finger 354 is located at an outer end of the second CPA element 350. Other locations are possible in alternative embodiments.

In various embodiments, the second CPA element 350 includes a second latch blocking finger 356 extending from the base 352. The second latch blocking finger 356 is configured to interface with the second latch 260. For example, the second latch blocking finger 356 may be positioned between the second latch 260 and the second side 232 of the outer housing 200 to block actuation of the second latch 260 when the second CPA element 350 is in the seated position. In the illustrated embodiment, the second latch blocking finger 356 is located at the rear of the base 352. Other locations are possible in alternative embodiments.

In an exemplary embodiment, the second engagement feature 360 is configured to interface with a portion of the outer housing 200, such as the second latch 260. The second engagement feature 360 includes a deflectable spring beam 362 that extends from the base 352 to a distal end 364. The second engagement feature 360 includes a blocking tab 366 extending inward from the spring beam 362 at the distal end 364. The blocking tab 366 includes an end surface 367 and an inner surface 368. The end surface 367 of the blocking tab 366 is configured to engage and abut against a portion of the second latch 260 to block movement of the second CPA element 350 relative to the outer housing 200 and the second latch 260. When the end surface 367 of the blocking tab 366 engages the second latch 260, the CPA device 300 is held in the pre-stage position and is unable to move to the seated position. In an exemplary embodiment, the inner surface 368 of the blocking tab 366 of the second engagement feature 360 is configured to interface with the second electrical connector 150 when the second electrical connector 150 is plugged into the second connector chamber 212. For example, the second inner surface 368 of the blocking tab 366 may interface with the second latching element 160 (when the second electrical connector 150 is fully plugged into the second connector chamber 212) and the second latching element 160 deflects the spring beam 362 of the second engagement feature 360 to the clearance position. The end surface 367 of the blocking tab 366 is released from the second latch 260 in the clearance position (for example, the blocking condition is removed) to allow the CPA device 300 to move to the seated position.

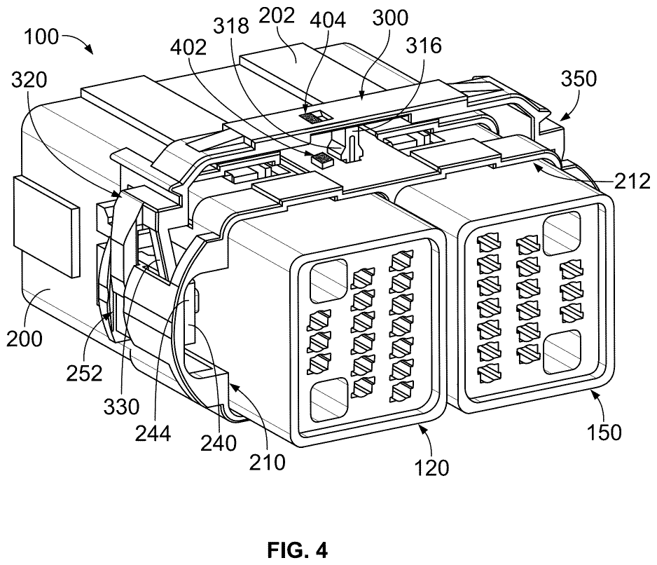

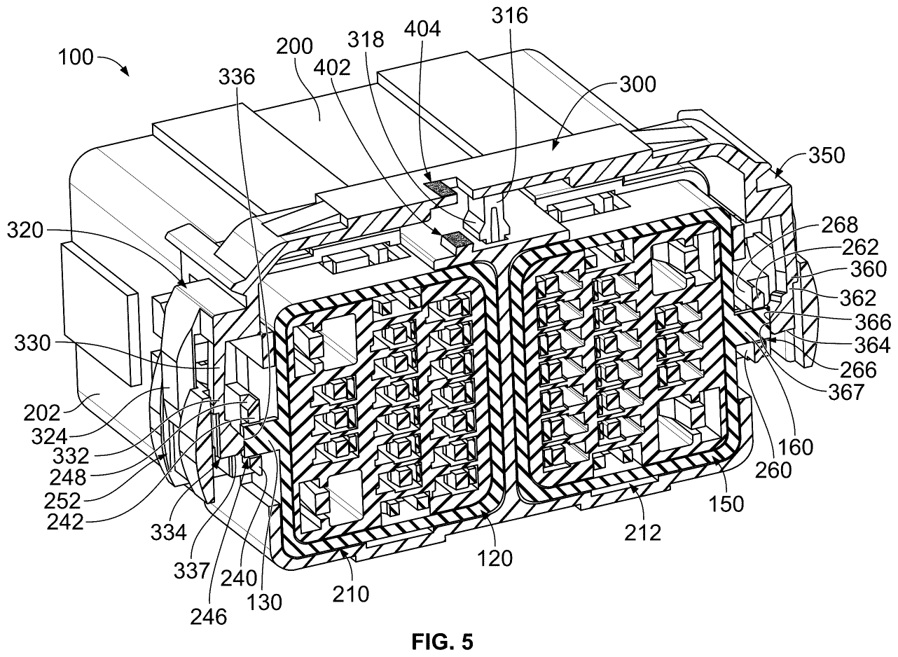

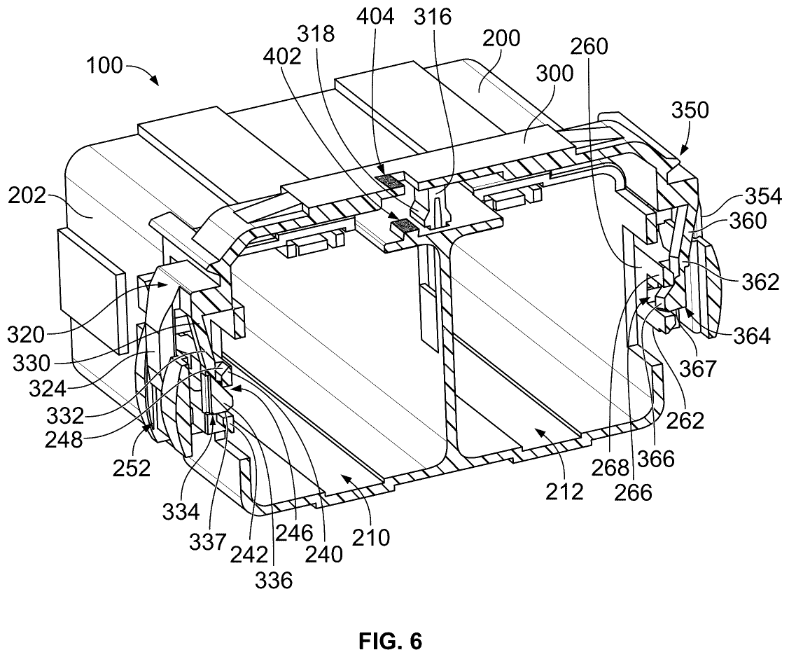

FIG. 4 is a perspective view of the electrical connector assembly 100 showing the CPA device 300 in a pre-stage position. FIG. 5 is a cross-sectional view of the electrical connector assembly 100 showing the CPA device 300 in the pre-stage position. FIG. 6 is a cross-sectional view of the electrical connector assembly 100 showing the CPA device 300 in the pre-stage position with the first and second electrical connectors 120, 150 removed to illustrate the CPA device 300 relative to the outer housing 200. In the pre-stage position, the first and second data matrix portions 402, 404 are separated from each other thus forming a split data matrix that is unscannable.

When assembled, the protrusions 318 along the center blocking finger 316 may engage the outer wall 202 to hold the CPA device 300 at the pre-stage position. When assembled, the first and second CPA elements 320, 350 may engage the outer housing 200 to position the CPA device 300 and/or hold the CPA device 300 at the pre-stage position relative to the outer housing 200. For example, the first and second guide fingers 324, 354 may be received in the first and second guide tracks 252, 272, respectively. The guide tracks 252, 272 guide movement of the guide fingers 324, 354, such as in a vertical direction to control movement of the CPA device 300 from the pre-stage position to the seated position (shown in FIG. 2). In an exemplary embodiment, the first and second engagement features 330, 360 engage the outer housing 200, such as at the first and second latches 240, 260, to hold the CPA device 300 at the pre-stage position. For example, the end surfaces 337, 367 of the blocking tabs 346, 366 engage the first and second latch 240, 260 to hold the CPA device 300 in the pre-stage position. The CPA device 300 is unable to move to the seated position when the engagement features 330, 360 are in the engagement positions (FIG. 6) and engage the outer housing 200 (for example, until the engagement features 330, 360 are moved to the clearance position (FIG. 5)).

In an exemplary embodiment, the first and second latches 240, 260 include latch windows 246, 266 in the latch arms 242, 262. The latch windows 246, 266 are openings having arm portions 248, 268 of the latch arms 242, 262 extending above and below the openings. The latch fingers 244, 264 are located forward of the latch windows 246, 266. The latch windows 246, 266 are configured to receive the first and second latching elements 130, 160 when the first and second electrical connectors 120, 150 are fully loaded into the outer housing 200. When the first and second latching elements 130, 160 are received in the latch windows 246, 266, the latching element 130, 160 are latchably coupled to the first and second latches 240, 260. For example, the latch fingers 244, 264 engage the latching elements 130, 160 and prevent removal of the first and second connectors 120, 150 from the outer housing 200.

When the CPA device 300 is in the pre-stage position, the blocking tabs 336, 366 at the distal ends 334, 364 of the spring beams 332, 362 are received in the latch windows 246, 266 and engage the arm portions 248, 268 when in the engagement positions (FIG. 6). However, when the first and second electrical connectors 120, 150 are fully loaded into the first and second connector chambers 210, 212, the first and second latching elements 130, 160 engage the blocking tabs 336, 366 and press the blocking tabs 336, 366 outward out of the latch windows 246, 266. The first and second latching elements 130, 160 move the first and second engagement features 330, 360 to the clearance positions. The first and second latching elements 130, 160 move the end surfaces 337, 367 of the blocking tabs 346, 366 clear of the arm portions 248, 268 and allow the CPA device 300 to move downward from the pre-stage position to the seated position. Only when both of the engagement features 330, 360 are moved to the clearance position is a CPA device 300 able to move from the pre-stage position to the seated position. For example, if one of the engagement features 330, 360 is in the engagement position (for example, when one of the electrical connectors 120, 150 is not fully loaded into the outer housing 200 and thus the latching elements 130, 160 are not received in the latch windows 246, 266), the CPA device 300 is still blocked from moving from the pre-stage position to the seated position. Only when both of the electrical connectors 120, 150 are fully loaded into the outer housing 200 is the CPA device 300 clear to move to the seated position.

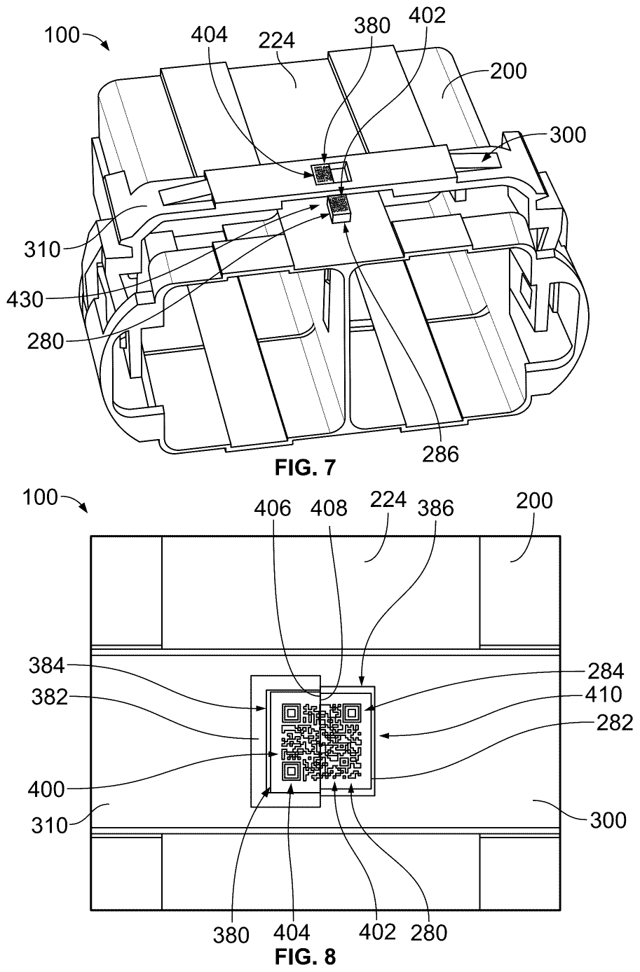

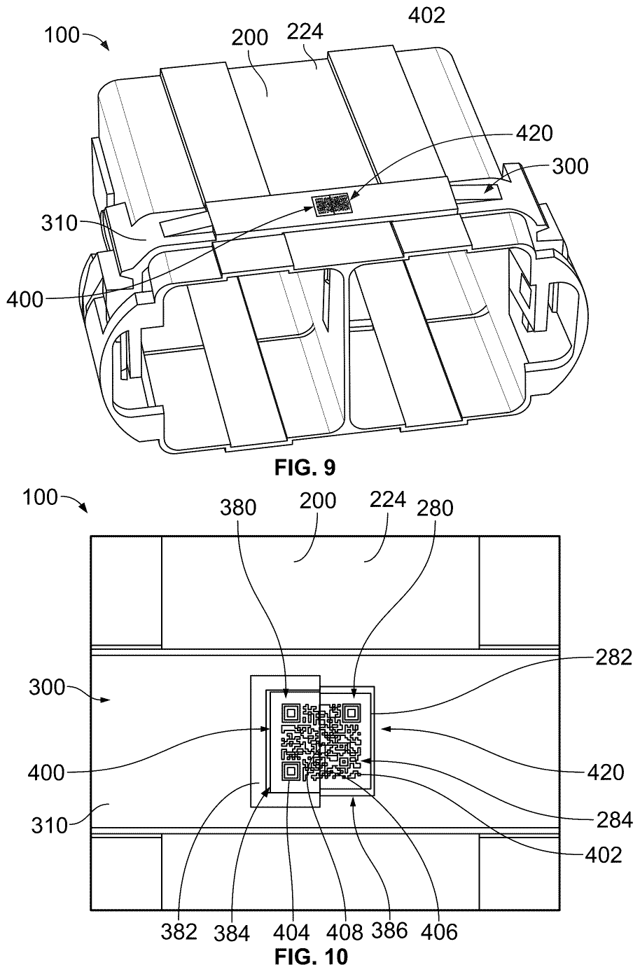

FIG. 7 is a top perspective view of the electrical connector assembly 100 showing the CPA device 300 in the pre-stage position and showing a split data matrix 410. FIG. 8 is a top view of a portion of the electrical connector assembly 100 showing the split data matrix 410. FIG. 9 is a top perspective view of the electrical connector assembly 100 showing the CPA device 300 in the seated position and showing the united data matrix 420. FIG. 10 is a top view of a portion of the electrical connector assembly 100 showing the united data matrix 420.

The electrical connector assembly 100 includes the data matrix 400 with the data matrix portions 402, 404 on different components, such as on the outer housing 200 and the CPA device 300, respectively. In an exemplary embodiment, the second data matrix portion 404 is movable relative to the first data matrix portion 402 with the CPA device 300 from the split position to the united position. The first and second data matrix portions 402, 404 are separated from each other when the CPA device 300 is in the pre-stage position to form the split data matrix 410 that is unscannable. The split data matrix 410 may be unscannable due to a parallax effect, such as due to being at different heights and/or based on changes in positions due to viewpoint angle. The split data matrix 410 may be unscannable due to an observable seam between the first and second data matrix portions 402, 404. The first and second data matrix portions 402, 404 are aligned adjacent each other when the CPA device 300 is in the seated position to form the united data matrix 420 that is scannable by the data scanning device. The CPA device 300 may include features, such as positioning ribs, magnetic elements, or other types of mechanical features for properly positioning the first and second data matrix portions 402, 404 adjacent each other, such as to minimize the seam and increases scanning readability. The pattern of the data matrix may have a robust finder patter or have a relatively large size to accommodate for scanning of the two halves of the united data matrix 420, such as to accommodate for any obscurity in the data matrix, such as from a slight seam or slight misalignment of the matrix portions 402, 404. The reader or scanner may use ECC200 error correction or other advanced error correction methods, such as employing Reed-Solomon algorithms, to allow data recovery from the united data matrix 420 being in an obscured state.

In an exemplary embodiment, the first data matrix portion 402 is provided at the data matrix area 280 of the outer housing 200, such as at the top 224 of the outer housing 200. For example, the first data matrix portion 402 may be coupled to the elevated platform 286 at the data matrix area 280 in the pocket 284. The embossed walls 282 extending along the first data matrix portion 402 on the sides thereof to protect the first data matrix portion 402.

In an exemplary embodiment, the second data matrix portion 404 is provided at the data matrix area 380 of the CPA device 300, such as along the main body 310. The second data matrix portion 404 is located adjacent the data matrix window 386. For example, the second data matrix portion 404 extends along the edge of the data matrix window 386. The embossed walls 382 surround the second data matrix portion 404, such as along three sides thereof to protect the second data matrix portion 404.

The data matrix window 386 is aligned with the elevated platform 286. For example, the data matrix window 386 may be located directly vertically above the elevated platform 286. The CPA device 300 is moved in a vertical direction, such as perpendicular to the mating direction of the electrical connectors 120, 150, from the pre-stage position to the seated position. The elevated platform 286 is received in the data matrix window 386 to align the first data matrix portion 402 with the second data matrix portion 404. In various embodiments, the elevated platform 286 may be sized the same as the data matrix window 386 such that the edges defining the data matrix window 386 center or position the elevated platform 286 within the data matrix window 386 to align the first and second data matrix portions 402, 404 with each other. In an exemplary embodiment, the platform 286 positions the first data matrix portion 402 coplanar with the second data matrix portion 404. The elevated platform 286 may be received in the data matrix window 386 by an interference or close fit to ensure that the first and second data matrix portions 402, 404 are aligned and joined to form the united data matrix 420.

In an exemplary embodiment, the first data matrix portion 402 includes a first inner edge 406 and the second data matrix portion 404 includes a second inner edge 408. The first and second inner edges 406, 408 are separated from each other by a gap 430 having a separation distance when the CPA device 300 is in the pre-stage position (FIG. 8). The first and second inner edges 406, 408 abut each other and are joined when the CPA device 300 is in the seated position (FIG. 10). For example, the gap 430 is eliminated in the united position when the CPA device 300 is in the seated position. The data matrix 400 is un-scannable when the first and second inner edges 406, 408 are spaced apart from each other. The data matrix 400 is readable and scannable when the first and second inner edges 406, 408 are joined.

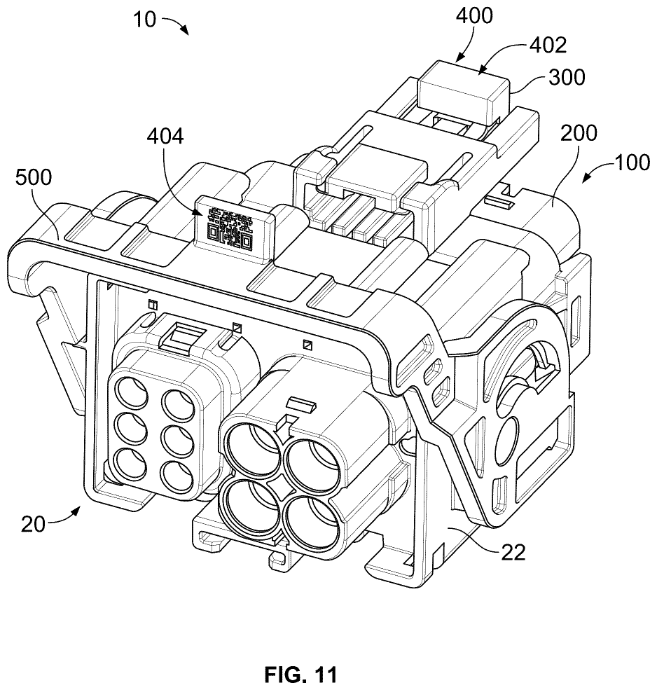

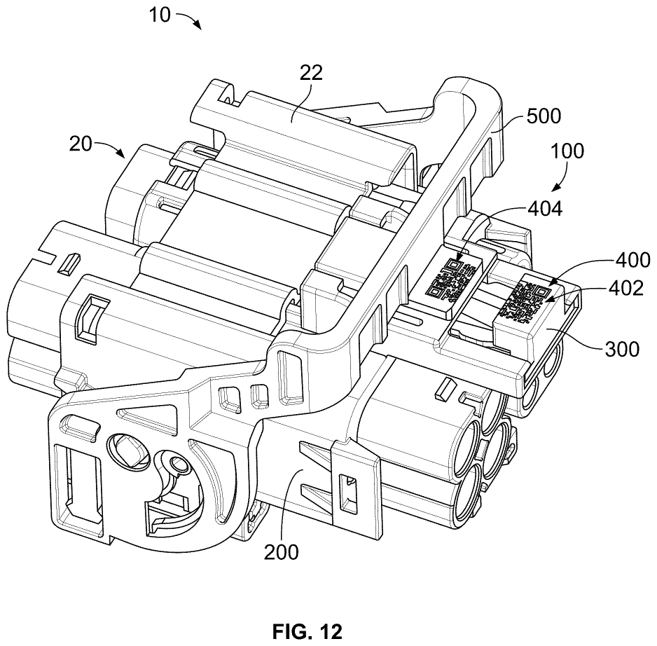

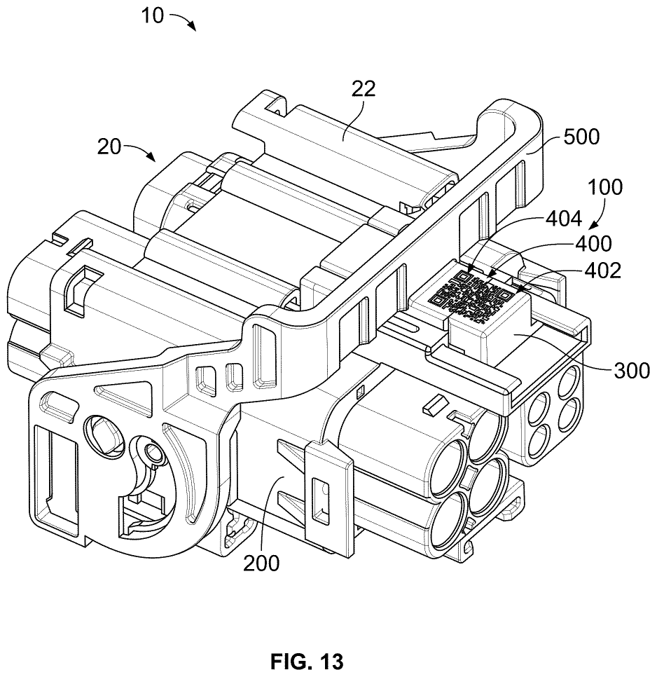

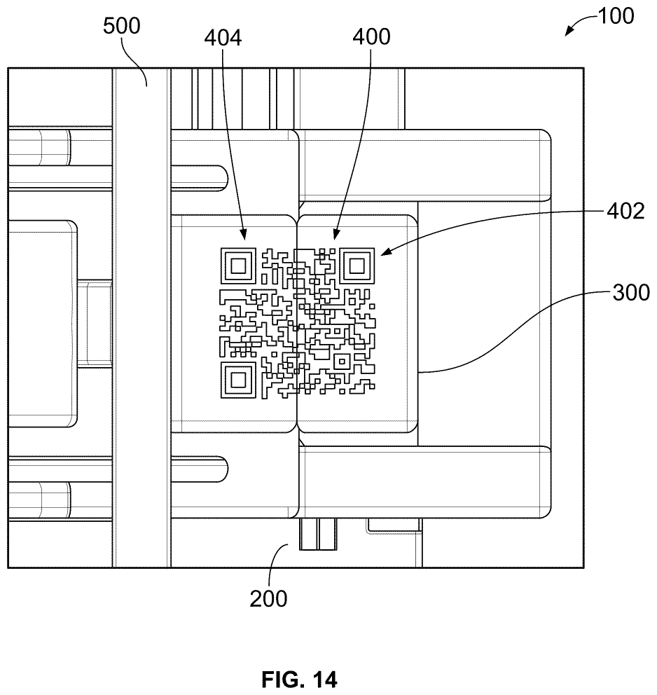

FIG. 11 is a perspective view of an electrical connector system 10 showing a mating connector assembly 20 partially mated with the electrical connector assembly 100. FIG. 12 is another perspective view of the electrical connector system 10 showing the mating connector assembly 20 partially mated with the electrical connector assembly 100. FIG. 13 is a perspective view of an electrical connector system 10 showing the mating connector assembly 20 fully mated with the electrical connector assembly 100. FIG. 14 is a top view of a portion of the electrical connector system 10 showing the data matrix 400 in a united and scannable state.

In the illustrated embodiment, the electrical connector system 10 includes a mating assist lever 500 to assist mating of the mating connector assembly 20 with the electrical connector assembly 100. In an exemplary embodiment, the mating assist lever 500 is coupled to a housing 22 of the mating connector assembly 20. In alternative embodiments, the mating assist lever 500 is coupled to the outer housing 200 of the electrical connector assembly 100. The mating assist lever 500 is rotatable relative to the outer housing 200 between an open position (FIGS. 11 and 12) and a closed position (FIG. 13).

The data matrix 400 includes a first data matrix portion 402 and the second data matrix portion 404. In an exemplary embodiment, the first data matrix portion 402 is on the mating assist lever 500 and the second data matrix portion 404 is on the CPA device 300. The first data matrix portion 402 is movable with the mating assist lever 500. The second data matrix portion 404 is movable with the CPA device 300. The first and second data matrix portions 402, 404 are separated from each other when the CPA device 300 is in the pre-stage position and/or when the mating assist lever 500 is in the open position to form a split data matrix that is unscannable. The first and second data matrix portions 402, 404 are aligned adjacent each other only when the CPA device 300 is in the seated position and the mating assist lever 500 is in the closed position to form a united data matrix that is scannable by the data scanning device. As such, the single data matrix 400 may be used to assure proper assembly of the connector assemblies 20, 100.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means - plus-function format and are not intended to be interpreted based on 35 U.S.C. § 112(f), unless and until such claim limitations expressly use the phrase “means for” followed by a statement of function void of further structure.

What is claimed is:

1. An electrical connector assembly comprising:
an electrical connector for mating with a mating connector, the electrical connector including a connector housing holding contacts, the electrical connector including a latching element, the electrical connector including an actuation element;
an outer housing including an outer wall surrounding a cavity receiving the electrical connector, the outer housing including a latch configured to be operably coupled to the latching element to secure the electrical connector in the cavity, the outer housing including a blocking surface;
a connector position assurance (CPA) device coupled to the outer housing, the CPA device movable between a pre-stage position and a seated position, the CPA device including a CPA element coupled to the blocking surface in the pre-stage position, wherein the blocking surface blocks the CPA device from moving from the pre-stage position to the seated position, the CPA element configured to interface with the actuation element of the electrical connector, wherein the actuation element is configured to move the CPA element to a clearance position released from the blocking surface when the electrical connector is fully inserted into the cavity, wherein movement of the CPA device into the seated position provides a mechanical indication that the electrical connector is properly positioned within the cavity of the outer housing and wherein movement of the CPA device is prevented when the electrical connector is not fully inserted in the outer housing; and
a data matrix including a first data matrix portion and a second data matrix portion, the second data matrix portion coupled to the CPA device and movable with the CPA device, wherein the first and second data matrix portions are separated from each other when the CPA device is in the pre-stage position to form a split data matrix, and wherein the first and second data matrix portions are aligned adjacent each other when the CPA device is in the seated position to form a united data matrix, the split data matrix being unscannable and the united data matrix being scannable by a data scanning device.

2. The electrical connector assembly of claim 1, wherein the second data matrix portion is movable relative to the first data matrix portion from a split position to a united position.

3. The electrical connector assembly of claim 2, wherein the second data matrix portion is spaced from the first data matrix portion by a gap in the split position, the gap being eliminated in the united position.

4. The electrical connector assembly of claim 1, wherein the first data matrix portion includes a first inner edge and the second data matrix portion includes a second inner edge, the first and second inner edges being separated from each other by a gap when the CPA device is in the pre-stage position, the first and second inner edges being joined when the CPA device is in the seated position.

5. The electrical connector assembly of claim 4, wherein the data matrix is un-scannable when the first and second inner edges are spaced apart from each other.

6. The electrical connector assembly of claim 4, wherein the first and second inner edges are spaced apart by a separation distance when the CPA device is in the pre-stage position, the first and second edges abutting each other when the CPA device is in the seated position.

7. The electrical connector assembly of claim 1, wherein the united data matrix is one of a one-dimensional barcode, a two-dimensional barcode, or a three-dimensional barcode.

8. The electrical connector assembly of claim 1, wherein the united data matrix is machine-readable and able to be read by a sensor of the data scanning device.

9. The electrical connector assembly of claim 1, wherein the first data matrix portion is provided on the outer housing.

10. The electrical connector assembly of claim 9, wherein the outer housing includes embossed walls surrounding the first data matrix portion.

11. The electrical connector assembly of claim 1, wherein the first data matrix portion is provided on a mating assist device movable relative to the outer housing between an actuated position and an un-actuated position.

12. The electrical connector assembly of claim 1, wherein the first data matrix portion is obscured and un-scannable when the CPA device is in the pre-stage position and the first data matrix portion is revealed and scannable when the CPA device is in the seated position.

13. The electrical connector assembly of claim 1, wherein the electrical connector is a first electrical connector, the outer housing holding a second electrical connector, the CPA device being movable to the seated position only when both the first and second electrical connectors are fully received in the outer housing.

14. The electrical connector assembly of claim 1, wherein the locking surface is provided on the latch, the CPA element engaging the blocking surface of the latch, the actuation element configured to release the CPA element from the blocking surface of the latch to allow the CPA device to move from the pre-stage position to the seated position.

15. The electrical connector assembly of claim 1, wherein the actuation element is provided on the latching element, the actuation element engaging the CPA element when the electrical connector is fully inserted into the cavity and the latching element engages the latch.

16. An electrical connector assembly comprising:
an electrical connector for mating with a mating connector, the electrical connector including a connector housing holding contacts, the electrical connector including a latching element, the electrical connector including an actuation element;
an outer housing including an outer wall surrounding a cavity receiving the electrical connector, the outer housing including a latch configured to be operably coupled to the latching element to secure the electrical connector in the cavity, the outer housing including a blocking surface;
a connector position assurance (CPA) device coupled to the outer housing, the CPA device movable between a pre-stage position and a seated position, the CPA device including a CPA element coupled to the blocking surface in the pre-stage position, wherein the blocking surface blocks the CPA device from moving from the pre-stage position to the seated position, the CPA element configured to interface with the actuation element of the electrical connector, wherein the actuation element is configured to move the CPA element to a clearance position released from the blocking surface when the electrical connector is fully inserted into the cavity, wherein movement of the CPA device into the seated position provides a mechanical indication that the electrical connector is properly positioned within the cavity of the outer housing and wherein movement of the CPA device is prevented when the electrical connector is not fully inserted in the outer housing; and
a data matrix including a first data matrix portion and a second data matrix portion, the first data matrix portion coupled to the outer housing, the second data matrix portion coupled to the CPA device and movable with the CPA device relative to the first data matrix portion, wherein the first and second data matrix portions are separated from each other when the CPA device is in the pre-stage position to form a split data matrix, and wherein the first and second data matrix portions are aligned adjacent each other when the CPA device is in the seated position to form a united data matrix, the split data matrix being unscannable and the united data matrix being scannable by a data scanning device.

17. The electrical connector assembly of claim 16, wherein the second data matrix portion is movable relative to the first data matrix portion from a split position to a united position, wherein the second data matrix portion is spaced from the first data matrix portion by a gap in the split position, the gap being eliminated in the united position.

18. The electrical connector assembly of claim 16, wherein the first data matrix portion includes a first inner edge and the second data matrix portion includes a second inner edge, the first and second inner edges being separated from each other by a gap when the CPA device is in the pre-stage position, the first and second inner edges being joined when the CPA device is in the seated position.

19. The electrical connector assembly of claim 16, wherein the first data matrix portion is obscured and un-scannable when the CPA device is in the pre-stage position and the first data matrix portion is revealed and scannable when the CPA device is in the seated position.

20. An electrical connector system comprising:
an electrical connector assembly including an outer housing holding an electrical connector and a connector position assurance (CPA) device, the electrical connector including a connector housing holding contacts, the electrical connector including a latching element, the electrical connector including an actuation element, the outer housing including an outer wall surrounding a cavity receiving the electrical connector, the outer housing including a mating assist tab, the outer housing including a latch configured to be operably coupled to the latching element to secure the electrical connector in the cavity, the outer housing including a blocking surface, the CPA device movable between a pre-stage position and a seated position, the CPA device including a CPA element coupled to the blocking surface in the pre-stage position, wherein the blocking surface blocks the CPA device from moving from the pre-stage position to the seated position, the CPA element configured to interface with the actuation element of the electrical connector, wherein the actuation element is configured to move the CPA element to a clearance position released from the blocking surface when the electrical connector is fully inserted into the cavity, wherein movement of the CPA device into the seated position provides a mechanical indication that the electrical connector is properly positioned within the cavity of the outer housing and wherein movement of the CPA device is prevented when the electrical connector is not fully inserted in the outer housing;
a mating connector assembly including a mating housing holding a mating electrical connector and a mating assist device, the mating electrical connector including mating contacts configured to be mated with the contacts of the electrical connector, the mating assist device including a lever configured to engage the mating assist tab and configured to drive at least one of the mating connector assembly and the electrical connector assembly in a mating direction as the lever is rotated between an unactuated position and an actuated position; and
a data matrix including a first data matrix portion and a second data matrix portion, the first data matrix portion coupled to the lever and movable with the lever between the actuated position and the unactuated position, the second data matrix portion coupled to the CPA device and movable with the CPA device, wherein the first and second data matrix portions are separated from each other when the CPA device is in the pre-stage position to form a split data matrix, and wherein the first and second data matrix portions are aligned adjacent each other when the CPA device is in the seated position to form a united data matrix, the split data matrix being unscannable and the united data matrix being scannable by a data scanning device.
